(19) United States
(12) Patent Application Publication
(10) Pub. No.: US 2014/0039090 A1
(43) Pub. Date: Feb. 6, 2014

(54) PROCESS OF MAKING A STABLE AQUEOUS DISPERSION OF CONCENTRATED, FINELY DIVIDED PARTICLES OF A BIOCIDE

(71) Applicant: ISP Investments Inc., Wilmington, DE (US)

(72) Inventors: Raman Premachandran, Saddle Brook, NJ (US); Blanca Gomez, Phillipsburg, NJ (US); Kolazi S. Narayanan, Wayne, NJ (US); Karen Winkowski, Springfield, NJ (US)

(73) Assignee: ISP Investments Inc., Wilmington, DE (US)

(21) Appl. No.: 14/049,880

(22) Filed: Oct. 9, 2013

Related U.S. Application Data
(62) Division of application No. 12/933,546, filed on Dec. 16, 2010.
(60) Provisional application No. 61/040,317, filed on Mar. 28, 2008.

(51) Int. Cl. A01N 25/04

(52) U.S. Cl. CPC A01N 25/04
USPC 523/122

(57) ABSTRACT

This invention provides a process of making a stable aqueous dispersion including concentrated, finely divided particles of a water insoluble biocide active, which comprises grinding the biocide in water in the presence of a non-ionic polymeric dispersant and optionally a co-dispersant, and compositions prepared by this process.

### FIELD OF INVENTION

This invention relates to a dispersion of biocides, and more particularly, to a process of making a stable aqueous dispersion of concentrated, finely divided particles of a biocide active, and compositions thereof.

### BACKGROUND OF THE INVENTION

Concentrated biocide compositions are difficult to prepare in stable and pumpable form due to their rapid aggregation and high viscosity. For example, the formulations described in U.S. Patent Pub. 2007-0224135 A1 which contained more than 25 wt % of a biocide were of high viscosity and not pumpable.

Other patents of interest are U.S. Pat. Nos. 6,506,794; 6,616,740; 6,140,370; 6,059, 991; 5,938,825; 4,552,885; and 4,276,211. Accordingly, it is an object of this invention to provide a process for making a stable aqueous dispersion of highly concentrated finely divided particles of a biocide which are pumpable dispersions.

### DETAILED DESCRIPTION OF THE INVENTION

The term “water insoluble biocide active” includes, but is not limited to, the following compounds: Iodopropynylbutylcarbamate (IPBC), Benzisothiazolone (BIT), Propiconazole, N(trichloromethylthio) phthalimide, methyl benzimidazol-2yl carbamate, tetrachloroisophthalonitrile, 2n-octyl-3-isothiazolone (OIT), Dibromonitriloproprianamide (DBNPA), 2-(thiocyanomethylthio)benzothiazole (TCMTB), Tebuconazole, Tributyl tinbenzoatc, Parabcns, 2,5-dimethyl-N-cyclohexy-N-methoxy-3-furan carboxamide, 5-Ethoxy-3 trichloromethyl-1,2,4 thiadiazole, 3-(2-methylpiperidino) propyl 3,4-dichlorobenzoate, N,N′-(1,4-piperazinediyl)bis(2,2,2-trichloro)ethylidene) bisformamide, Tetramethylthiuram disulfide, 0-Ethyl-S,S,diphenyl-dithiophosphate, 5-10-dihydro-5,10-dioxonaphtha(2,3,9)-p-dithiin-2,3-dicarbonitrile, a-2-[(4-chlorophenyl)1,1-dimethylurea, N-tridecyl-2,6-dimethylmorpholine, 4-dodecyl-2,-6-dimethylmorpholine, diethefencarb, diuron, Zinc Pyrithione, Carbendazim, Chlorothalonil, Zineb, Ziram, Dimethomorph, Thiabendazole, difenoconazole, and thiram.

The terms “anionic polymeric dispersant” refers to polymers comprising at least one group derived from carboxylic acid, sulphonic acid or phosphoric acid and such as those having a weight-average molecular weight ranging approximately from 500 to 5,000,000, determined, for example, by gel permeation chromatography. Accordingly, “anionic polymeric dispersant” includes, but are not limited to the following compositions: the sodium salt of methyl vinyl ether/maleic acid half-ester copolymer, optionally with polyvinylpyrrolidone, (e.g., EASY-SPERSE), a lignosulfonate or metal salt thereof, (e.g., POLYFON, UFOXANE or MARSPERSE); a sulfonated naphthalene/formaldehyde condensate (e.g., MORWET®); a high molecular weight block copolymer with pigment affinic group (e.g., DISPERBYCK 190); polyacrylates; ammonium polycarboxylates; sodium salt of polycarboxic acid; 1,4 bis(2-ethylhexyl)sodiumsulfosuccinate (e.g., TRITON GR PG 70); polyether-polycarbonate sodium salt (e.g., ETHACRYL P); maleic acid-olefin co-polymer (e.g., VULTAMOL NN 4501); ammonium polyacrylate (e.g., DISPEX GA 40); C6-C15 secondary alcohol and alkyl aryl sulfonate (e.g., ZETASPERSE 2300) and alkyl naphthalene sulfonate (e.g., AGNIQUE).

The term nonionic polymeric dispersants” include, but are not limited to, high molecular weight non-ionic EO/PO block copolymers, EO/PO block copolymers known as Pluronies® from BASF, polymers of acrylic acid and methacrylic acid, C11-C15 secondary ethoxylated alcohols and diols, PEG-PLGA-PEG copolymers, and polyether polyols.

The term “UV blocker” includes, but is not limited to, the following compounds: titanium dioxide, zinc oxide, iron oxide, and polymeric particles such as polyethylene and polyamides.

The term “UV absorber” includes, but is not limited to, avobenzone, PABA, para-aminobenzoic acid, cinnoxate, dioxybenzone, homosalate, menthyl anthranilate, octocrylene, octylmethoxycinnamate, octyl salicylate, oxybenzone, padimate O, Phenylbenzimidazole, sulfonic acid, sulisobenzone, and trolamine salicylate.

The term “optional co-dispersant” includes, but is not limited to a vinyl lactam which is suitably the homopolymer of vinyl pyrrolidone or vinyl caprolactam either optionally substituted on the ring or in the vinyl group with lower alkyl (C1 to C4 alkyl), or a mixture of these homopolymers, e.g., EasySperse P20 (ISP). Alternatively, the co-dispersant can be a copolymer of vinyl pyrrolidone and/or vinyl caprolactam, e.g., vinyl pyrrolidone/vinyl caprolactam copolymer, vinyl pyrrolidone/vinyl acetate, vinyl pyrrolidone/acrylic acid, vinyl pyrrolidone/acrylate, vinyl pyrrolidone and butane, or a vinyl pyrrolidone and a C14-C24 alpha-olefin and glyceryl polyacrylate.

The term “Hegman”, as used herein, relates to ASTM method D1210, also known as the Standard Method for Fineness. This method measures the dispersion of a pigment-vehicle system using the Hegman-Type gage. Specifically, the method covers measurements of the degree of dispersion (commonly referred to as “fineness of grind”) of the pigment in a pigment-vehicle system such as a liquid coating and their intermediates. It may also be used to assess the inclusion of particulates by a cleanliness rating. This method is important in making pigmented products because any pigment agglomerates must be sufficiently broken up so as to interfere with the smoothness of the finished coating film. This test method describes a way of making this judgment. Typically, a Hegman reading of 6 or higher corresponds to a cleanliness rating A, and a particle size of less than 25 microns.

The present invention is prepared by methods known to those skilled in the formulation arts.

What is described herein is a process of preparing low viscosity substantially neutral pH, high load, water-insoluble biocidal dispersions containing biocide particles in the size range of about 100-500 mm. In this process, approximately 70 wt. % water is mixed with a milking or grinding aid and half the required weight of thickener to provide a composition of suitable viscosity comprising the biocide particles. To this solution is added a dispersant, a co-dispersant, additional milling aid, UV blocker, biocide carrier and biocide. The mixture is milled using a selected weight of a suitable grinding media, preferably zirconium beads (0.85-1.02 mm) in a ball mill. When the Hegman value exceeds 6, the rest of the water and thickening agent is added and the dispersion is further milled for 30 min. The resultant particle size of the biocide particles ranges from 100-500 nm as determined by light scattering measurements. The dispersion was pumpable and easy to incorporate into end use products without settling.

For optimum results the following parameters were followed.
1. The milling technique and selected dispersant reduced the dispersion viscosity and particle size of the biocide even at a high load thereof.
2. The viscosity obtained ranged from 100-4000 CP based upon the amount of thickening agent added.
3. Pluronics added as a primary dispersant and EasySperse P20 as a co-dispersant and anchor for the biocide. Synergistic dispersions are obtained with a mixture of the two. EasySperse P20 in the partically neutralized butyl half-ester of a copolymer of poly (methylvinylether/maleic acid) and poly vinylpyrrolidone.
4. The resultant product was conveniently incorporated into paints and building materials with substantially zero VOC.

The invention will now be described with reference to the following examples.

### EXAMPLE 1

| Ingredient | Weight % |
|---|---|
| Water | 52.8 |
| Surfynol 465 (wetting/grinding) | 1.0 |
| Pluronic L 100 (dispersant) | 1.5 |
| EasySperse P 20 (co-dispersant) | 1.0 |
| Huber 90 (kaolin) biocide carrier | 0.5 |
| Cabosil TS 530 (hydrophobized silica) | 0.5 |
| TiO2 (UV blocker) | 2.5 |
| IPBC (biocide) | 40.0 |
| Rapithix A-100, (polyacrylate thickener) | 0.2 |

pH = 6.5 Viscosity 2800 CP

### EXAMPLE 2

| | Weight % |
|---|---|
| Water | 52.0 |
| Surfynol CT 111 (grinding aid) | 2.5 |
| Pluronic L101 | 1.5 |
| Pluronic P103 | 2.5 |
| TiO2 | 0.5 |
| Huber 90 | 0.5 |
| IPBC | 40.0 |
| Kelzan (thickener, Xanthan gum) | 0.1 |

pH = 6.3, Viscosity 1900 CP

### EXAMPLE 3

| | Weight % |
|---|---|
| Water | 54.0 |
| Surfynol CT 111 | 0.9 |
| Huber 90 | 0.75 |
| TiO2 | 2.25 |
| Pluronic P 103 | 1.0 |
| Pluronic L 101 | 1.0 |
| IPBC | 40.0 |
| Kelzan | 0.1 |

pH = 6.2 Viscosity 150 CP

### EXAMPLE 4

| | Weight % |
|---|---|
| Water | 44.0 |
| Surfynol CT 111 | 0.9 |
| Huber 90 | 0.75 |
| Titanium dioxide | 2.25 |
| Kalzan | 0.05 |
| Pluroinc L 101 | 1.00 |
| Pluronic P 103 | 1.0 |
| EasySperse P 20 | 0.75 |
| IPBC | 50.00 |

pH = 6.1, Viscosity 250 CP

### EXAMPLE 5

| | Weight % |
|---|---|
| Water | 53.5 |
| Veegum granules (smectite clay) | 1.75 |
| Vanzan D (Xanthan gum) | 0.15 |
| Pluronic P 103 | 1.05 |
| Pluronic L 101 | 0.95 |
| ZnO | 1.25 |
| Sudynol CT 111 | 0.9 |
| IPBC | 40.0 |

pH = 6.4 Viscosity 200 CP

### EXAMPLE 6

| | Weight % |
|---|---|
| Water | 53.75 |
| Kelco CMC (carboxy methyl cellulose) | 0.25 |
| Veegum granules | 0.75 |
| Pluronic P 103 | 1.05 |
| Pluronic L 101 | 0.95 |
| EasySperse P 20 | 0.75 |
| Titanium dioxide | 2.25 |
| Surfynol CT 111 | 0.9 |
| IPBC | 40.0 |

pH = 6.2 Viscosity 700 CP

### EXAMPLE 7

| | Weight % |
|---|---|
| Water | 52.85 |
| Veegum granules | 0.75 |
| Pluronic P 103 | 1.05 |
| Pluronic L 101 | 0.95 |
| EasySperse P 20 | 0.75 |
| Titanium dioxide | 2.25 |
| Surfynol CT 111 | 0.9 |
| Sodium alginate | 0.50 |
| IPBC | 40.0 |

pH = 6.4 Viscosity 700 CP

### EXAMPLE 8

| | Weight % |
|---|---|
| Water | 53.1 |
| Xanthan gum | 0.25 |
| Pluronic L 101 | 1.01 |
| Pluronic P 103 | 1.9 |
| Huber 90 (kaolin) | 1.5 |
| Titanium dioxide | 2.25 |
| Surfynol CT 111 | 0.90 |
| IPBC | 40.0 |

The invention has been described in detail with particular reference to preferred embodiments thereof, but it will be understood that variations and modifications can be effected within the spirit and scope of the invention.

1. (canceled)

2. (canceled)

3. (canceled

4. (canceled)

5. (canceled)

6. (canceled)

7. (canceled)

8. (canceled)

9. (canceled)

10. (canceled)

11. (canceled)

12. (canceled)

13. (canceled)

14. A stable aqueous dispersion composition comprising concentrated, finely divided particles with of lodo Propynyl Butyl Carbamate (IPBC), a biocide, and a dispersant which is a nonionic polymeric dispersant; optionally including a co-dispersant which is a partially neutralized butyl half-ester of a copolymer of poly(methyl vinyl ether/maleic acid) and polyvinyl pyrrolidone.

15. A composition according to claim 14, wherein said dispersant is an EO/PO polymer.

16. (canceled)

17. (canceled)

18. A composition according to claim 14, wherein biocide is present in a concentration of 20-60% by weight.

19. A composition according to claim 14, wherein said dispersant is an EO/PO block polymer having a molecular weight of at least 5000 amu.

20. A composition according to claim 14, wherein the particle size of said particle is less than 500 nm.

21. A composition according to claim 20, wherein said particle size is about 100-300nm.

22. A composition according to claim 14, which is a paint, a building material, a polymer, a metal working fluid or a wood treatment composition.

23. A composition according to claim 22, which includes a clay, a stabilizer and/or a UV block or absorber.
